(19) United States
(12) Patent Application Publication
(10) Pub. No.: US 2025/0209132 A1
(43) Pub. Date: Jun. 26, 2025

(54) EFFICIENT MULTIPLY-ACCUMULATE UNITS FOR CONVOLUTIONAL NEURAL NETWORK PROCESSING INCLUDING MAX POOLING

(71) Applicant: Tesla, Inc., Austin, TX (US)

(72) Inventors: Peter Sassone, Austin, TX (US); Peter Joseph Bannon, Woodside, CA (US)

(21) Appl. No.: 18/842,739

(22) PCT Filed: Mar. 2, 2023
(86) PCT No.: PCT/US2023/014350

§ 371 Date: Aug. 29, 2024

Related U.S. Application Data
(60) Provisional application No. 63/316,804, filed on Mar. 4, 2022.

(51) Int. Cl. G06F 17/16

(52) U.S. Cl. CPC G06F 17/16

(57) ABSTRACT

Systems and methods for enhanced multiply-accumulate units for convolutional neural network processing. An example multiply-accumulate unit includes a multiplier, with the multiplier being configured to receive (1) an input value of a window of input values and (2) a weight value set to negative one. The unit further includes an adder, with the adder being configured to add a result received from the multiplier with a value in an accumulator of the MAC unit. The unit further includes a multiplexer, with the multiplexer being configured to select between outputting (1) a result of the adder and (2) the input value; and the accumulator, and with the accumulator being configured to receive output from the multiplexer, and with the accumulator being configured to be enabled or disabled according to the result of the adder based on the MAC unit performing a particular convolutional operation.

### CROSS-REFERENCE TO RELATED APPLICATIONS

This application claims priority to U.S. Prov. Patent App. No. 63/316,804 titled “EFFICIENT MULTIPLY-ACCUMULATE UNITS FOR CONVOLUTIONAL NEURAL NETWORK PROCESSING INCLUDING MAX POOLING” and filed on Mar. 4, 2022, the disclosure of which is hereby incorporated herein by reference in its entirety.

### BACKGROUND

### Technical Field

The present disclosure relates to a hardware processor, and more particularly, to enhanced multiply-accumulate units.

### Description of Related Art

Neural networks are relied upon for disparate uses and are increasingly forming the underpinnings of technology. For example, a neural network may be leveraged to perform object classification on an image obtained via a user device (e.g., a smart phone). In this example, the neural network may represent a convolutional neural network which applies convolutional layers, pooling layers, and one or more fully-connected layers to classify objects depicted in the image. As another example, a neural network may be leveraged for translation of text between languages. For this example, the neural network may represent a recurrent-neural network, transformer network, and so on.

Typically, a graphics processing unit (GPU) may be used at training or inference time. As may be appreciated, a GPU can perform rapid mathematical calculations of a kind suitable for certain layers of a neural network. For example, a GPU can rapidly calculate a forward pass through a fully-connected layer based on multiplying different vectors. However, GPUs are not optimized for specific neural network use-cases. This may reduce the complexity that a neural network can be to achieve inference times less than a particular time constraint. For example, a neural network which performs object recognition on images obtained from a camera may be limited in how many images can be processed per second.

### BRIEF DESCRIPTION OF THE DRAWINGS

FIG. 1 is a block diagram illustrating an example prior art matrix processor configured for performing convolutional neural network operations.

FIG. 2A is a block diagram illustrating an example matrix processor which includes enhanced multiply-accumulate units (MAC units) according to the techniques described herein.

FIG. 2B is a block diagram illustrating detail of an example MAC unit.

FIG. 3 is a flowchart of an example process for performing a convolutional neural network operation, such as max pooling, using the enhanced MAC units described herein.

FIG. 4 is a block diagram illustrating an example vehicle which includes the vehicle processor system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

This application describes an enhanced multiply-accumulate (MAC) unit which may be included, optionally along with other MAC units, in a matrix processor. In some embodiments, the matrix processor may perform convolutional neural network processing (e.g., the matrix processor may be a convolution engine). For example, the matrix processor may compute a forward pass of information through layers which form a convolutional neural network. Example information may include images from image sensors, such as image sensors positioned about an autonomous or semi-autonomous vehicle. As will be described, the enhanced MAC unit described herein may allow for performance of certain operations which are commonly used in processing associated with a convolutional neural network. An example of such an operation includes pooling, such as max pooling.

An example hardware processor, such as a convolutional engine, may be configured for efficient processing of convolutional neural networks. For example, the hardware processor may obtain image data (e.g., vectorized data) and filters or kernels to be applied to the image data. In this example, the hardware processor may have a matrix processor which has a matrix of MAC units configured to compute, at least, dot products between the image data and filters or kernels. The output of the matrix processor may represent the output of a convolutional layer included in a convolutional neural network. The output may also represent the output associated with an individual output channel. A non-linear activation function may then be applied to the above-described output, for example via a different hardware unit or element.

With respect to pooling, the hardware processor may include another hardware unit or element which performs the pooling. For example, and with respect to a max pooling layer, the hardware unit or element may identify a maximum value within a window of values included in the input to the max pooling layer. An example window may be 2×2, for example with a stride of 2, such that the max pooling layer subsamples every depth slice in the input by 2 along both width and height. As an example, the max pooling layer identifies a maximum value in a first 2×2 input portion and then identifies a maximum value in a second 2×2 input portion which is two positions in width away from the first portion.

As may be appreciated, use of a separate hardware unit or element to perform post-processing, such as max pooling, may increase a complexity and die space utilized by the hardware processor. Additionally, and with respect to an electric vehicle, the power requirements may be greater.

Described herein are example enhanced MAC units which allow for increased performance associated with performing max pooling. As will be described below, an enhanced MAC unit may include example hardware to enable performance of max pooling. An example of such hardware includes a multiplexer, such as a 2-to-1 multiplexer, which multiplexes between (1) input data and (2) output of an addition operation which adds an accumulated value to a multiplication of input data with weight data (e.g., kernel or filter data). The multiplexer may select between the two multiplexed sources depending on whether a first operation (e.g., convolution) is being performed or whether a second operation (e.g., max pooling) is being performed.

To allow for max pooling, and thus a comparison of values in a window of input values, the enhanced MAC unit may receive (1) an input value in a window of input values and (2) a weight of negative 1. The multiplication of these values may thus represent a negative of the input value. This multiplication may be added to an accumulated value, such as a prior input value in the window of input values, and a comparison may be identified based on the addition. For example, a high bit of the result may indicate whether the input value is greater than the prior value or whether the input value is less than the prior value. If the result is greater, then the input value may be stored as the accumulated value (e.g., in the accumulator element). For example, the accumulator may be enabled based on the value of the high bit. If the result is less, then the accumulated value may remain as the prior value. For example, the accumulator may be disabled based on the value of the high bit. In these examples, the high bit may thus be input into an enable/disable of the accumulator.

The above-described enhanced MAC unit may thus be leveraged to reduce a complexity and/or die size associated with a matrix processor used for autonomous or semi-autonomous driving. Indeed, the adjustment of the MAC units through use of a multiplexer may allow for more efficient processing of information and a reduction in complexity.

The MAC units may be included in a matrix processor, such as the matrix processor described in U.S. Pat. No. 11,157,287, U.S. Patent Pub. 2019/0026250, and U.S. Pat. No. 11,157,441, which are hereby incorporated by reference in their entirety and form part of this disclosure as if set forth herein. In some embodiments the matrix processor is a non-systolic array of MAC units, with input data being provided to one direction of the matrix processor and weight data being provided to a second direction of the matrix processor.

In some embodiments, the MAC units described herein (e.g., enhanced MAC units) may be arranged such that a tree-like reduction may be performed. For example, a first number of MAC units may determine a maximum value in their respective portion of an input window. As an example, 4 MAC units may determine a maximum value of a 4×4 sub-matrix of a 8×8 input window. Output of these 4 MAC units (e.g., 4 values) may be provided to a single MAC unit to determine the maximum. Output may also be provided to two MAC units (e.g., 2 values provided to each MAC unit, such as in successive clock cycles) followed by 1 MAC unit to determine the maximum.

As may be appreciated, numerous topologies of MAC units described herein may be used in a processor and fall within the scope of the disclosure herein.

In some embodiments, the techniques described herein may be used to determine a minimum value in a pooling window. For example, an accumulator may initially store a default value as described herein (e.g., a highest value representable). In this example, an input data value, multiplied by negative one, may be added to the default value and based on a high bit indicating the addition is positive, the accumulator may be enabled to store the input data value.

### Block Diagrams

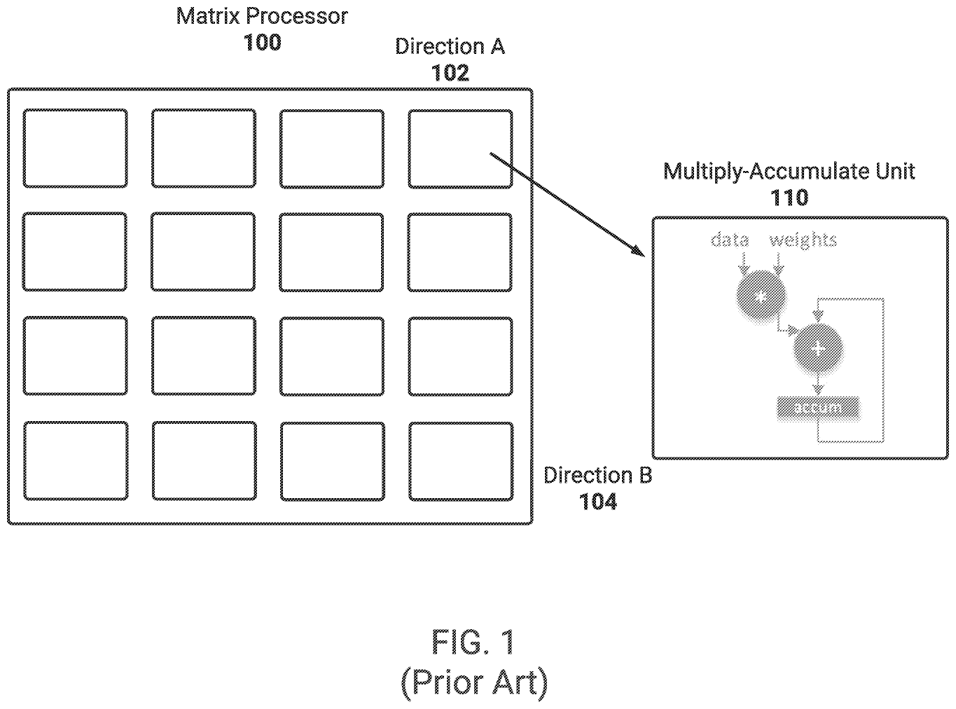

FIG. 1 is a block diagram illustrating an example prior art matrix processor 100 configured for performing convolutional neural network operations. The example matrix processor 100 includes a multitude of multiply-accumulate units (MAC units) which may process convolutional layers of a convolutional neural network.

As an example, the matrix processor 100 may receive input data along Direction A 102 of the matrix processor 100. For example, the input data may represent a vectorized form of one or more images obtained from image sensors. As another example, the matrix processor 100 may receive weight data (e.g., one or more filters, kernels) along Direction B 104 of the matrix processor 100. For example, the weight data may represent a vectorized form of the weight data.

The matrix processor 100 may compute one or more convolutions associated with the input data and weight data using the multitude of MAC units. For example, the MAC units may compute dot products of portions of the input data and weight data. These dot products may be used to generate the one or more convolutions.

An example MAC unit 110 is included in FIG. 1. As illustrated, the MAC unit 110 includes a first element which multiplies input data and weight data. Additionally, the MAC unit 110 includes a second element which adds the result of the first element to an accumulated value stored in an accumulator. In this way, multiplications of weight data and input data may be added over clock cycles of the matrix processor 100.

While the matrix processor 100 may efficiently perform convolutions using MAC units, the MAC units lack the ability to perform other operations commonly relied upon in convolutional neural networks. For example, the matrix processor 100 may require additional hardware elements to perform max pooling.

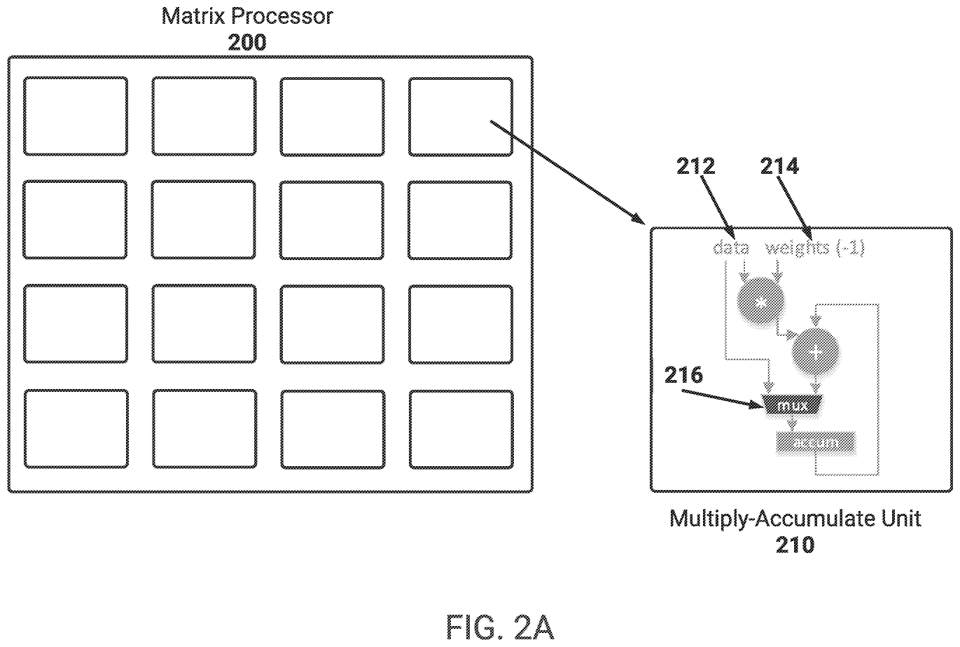

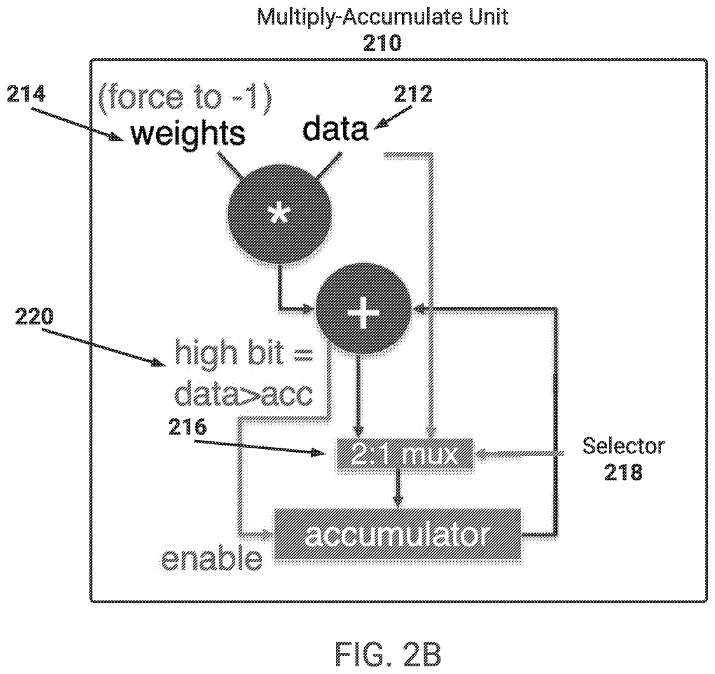

FIG. 2A is a block diagram illustrating an example matrix processor 200 which includes enhanced multiply-accumulate units (MAC units) according to the techniques described herein. The matrix processor 200 includes an example of an enhanced MAC unit 210 according to the techniques described herein. The example matrix processor 200 may be used to perform convolutional neural network processing, for example with one output channel being active for a given input channel of data. As may be appreciated, this may adjust a normal operation (e.g., pooling may traditionally be depthwise).

The enhanced MAC unit 210 may be used to compute or determine the maximum of a set of input values. In the illustrated embodiment, the enhanced MAC unit 210 receives an input value 212. For example, the input value 212 may represent an input value from a window of input values associated with a size of a max pooling operation being performed. Example sizes may include a 2×2 operation, a 3×3 operation, and so on. Values in a window of input values may be successively provided to the enhanced MAC unit 210 to enable comparison of these input values.

The enhanced MAC unit 210 additionally receives a weight value of negative one, thus causing the input value 212 to be negative. For example, the matrix processor 200, or a controller associated with the processor 200, may cause the weight to be a value of negative one. In this example, an instruction associated with performing max pooling may cause this weight value to be input. As will be described below, with respect to FIG. 2B, the negative input value 212 may be added to a prior input value in the accumulator. The result of this addition may thus indicate whether the input value 212 is greater than the prior input value.

The enhanced MAC unit 210 additionally includes a multiplexer 216. During processing of a convolutional layer, the multiplexer 216 may be set to select from a first source (e.g., the output of the addition). For example, the matrix processor 200 may execute a software or hardware command or instruction which causes selection of the first source. In this way, the multiplexer 216 may pass values output from the addition for inclusion or storage in the accumulator. During processing of a max pooling layer, the multiplexer 216 may instead be set to select from a second source (e.g., the input data). Thus, the input data may be stored in the accumulator depending on whether the input data is larger than (e.g., larger than, larger than or equal to) a prior input value.

FIG. 2B is a block diagram illustrating detail of the example enhanced MAC unit 210. As described above, with respect to FIG. 2A, input data 212 (e.g., an input value) may be provided to the enhanced MAC unit 210 along with weight data 214 which is set to negative one. For example, a software or hardware operation may cause the weight data 214 to be set to negative one when the matrix processor 200 is performing a max pooling operation.

In the illustrated example, the multiplexer 216 is set to select a particular source (e.g., input data 212) via selector 218. For example, the selector 218 may be toggled between sources based on whether the matrix processor 200 is processing a convolutional layer or processing a max pooling layer. In this example, the selector 218 may be set based on an instruction being performed.

Example operation of the enhanced MAC unit 210 may include the input data 212 being a first value in a window of input values. In this example, there may be no accumulated value such that the value is set to a default (e.g., zero). The input data 212 is multiplied by negative one and the output of the multiplication if added to the default. Since this first value, in some embodiments, may be positive (e.g., assuming the input is image data), the result of the addition will be negative. For example, if the first value is 7 then the multiplication will be negative 7 and the result of the addition will remain as negative 7.

With respect to a default value, the accumulator may be reset before determining a maximum value in a window of values. For example, when doing the maximum of a series of unsigned values, the accumulator may be reset to zero (e.g., the minimum unsigned value). As another example, when performing a maximum of signed values, the reset value may be the smallest negative number representable by the input data width of the MAC (e.g., 0xffff . . . ). An alternative to these reset cases is just to override the circuit to capture the first data into the accumulator and thus there is no reset value needed.

In the above example, since the result of the addition is negative, the high bit 220 will be set to a particular value (e.g., one, with respect to a signed magnitude representation). This high bit may be used, for example when processing a max pooling layer, to enable or disable the accumulator. Since, as an example, the high bit 220 is one, the accumulator will be enabled. Thus, the input data 212 will be transferred through the multiplexer 216 and stored or included in the accumulator.

Subsequently, a next input value within a window of input values may be obtained. The next input value may be provided in a subsequent clock cycle in some embodiments. Similar to the above, the next input value will be multiplied with negative one and the result of the multiplication added to the accumulated value. If the next input value is larger than the accumulated value, the high bit 220 will be set to one and the accumulator will store the next input value. However, if the next input value is less than the accumulated value, the high bit 220 will be set to zero and the accumulator will be disabled. In this way, accumulated value will remain.

Upon a final value within the above-described window of values being processed through the enhanced MAC unit 210, the value stored in the accumulator will represent a maximum value within the window of values.

In some embodiments, when processing a convolutional layer, the high bit 216 may be ignored or set to one. In this way, the accumulator may function as normal. However, when processing a pooling layer, the high bit may be used to indicate whether the accumulator should be enabled or disabled.

### Example Flowchart

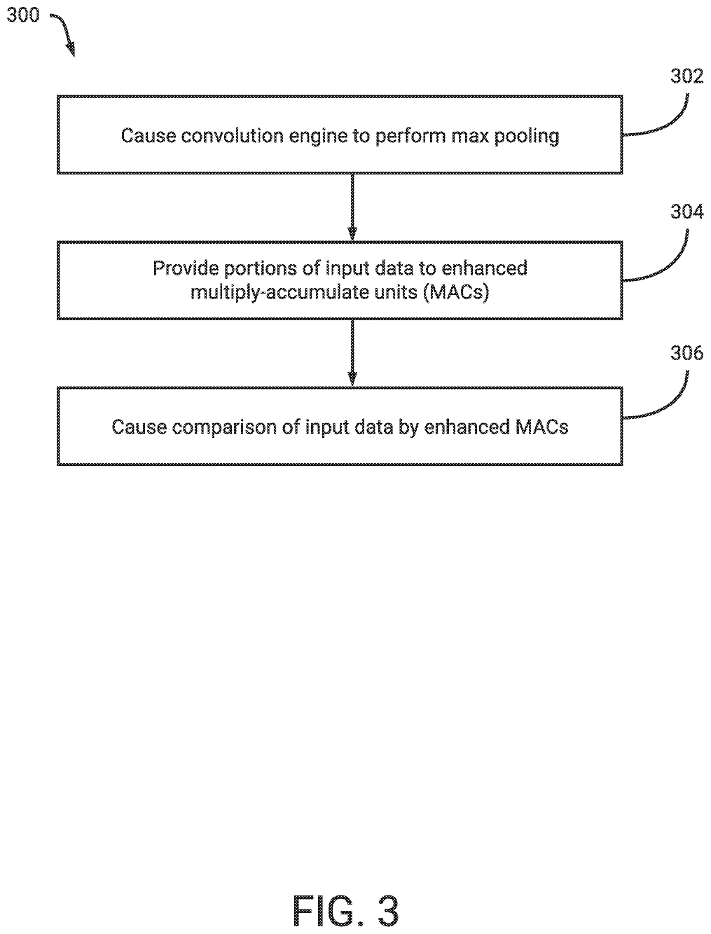

FIG. 3 is a flowchart of an example process 300 for performing a convolutional neural network operation, such as max pooling, using the enhanced MAC units described herein. For convenience, the process 300 will be described as being performed by a matrix processor which includes a multitude of enhanced multiply-accumulate units (MAC units).

At block 302, the matrix processor causes a convolution engine to perform max pooling. The matrix processor, which may be referred to as a convolution engine, may execute one or more instructions which are associated with performance of max pooling. For example, max pooling may be defined, in some embodiments, via indication of input data, a window size, stride, and so on. The input data may represent an output from a prior layer of a neural network and may be a prior pooling layer, a prior convolutional layer, and so on.

As described above, the enhanced MAC units may be configured for use in max pooling. For example, selectors (e.g., selector 218) of multiplexers included in the enhanced MAC units may be set to a particular value which causes selection of input data. In this example, the output of the multiplexers may be routed to accumulators in the enhanced MAC units. Thus, the enhanced MAC units may be configured to store input data which is routed through the multiplexers.

At block 304, the matrix processor provides portions of input data to the enhanced MAC units. As described above, max pooling may represent identifying respective maximum values in a multitude of windows of input values. For example, a size of a max pooling window may be 2×2, and a stride may be set to 2. In this example, and for ease of reference, the input data may include 4 windows (e.g., the input data may have 16 values). In some embodiments, each of the enhanced MAC units may operate on a respective window. With respect to four windows, four enhanced MAC units may identify respective maximum values in the four windows.

At block 306, the matrix processor causes comparison of the input data. As described in FIGS. 2A-2B, each enhanced MAC unit may identify a maximum value in a respective window.

### Vehicle Block Diagram

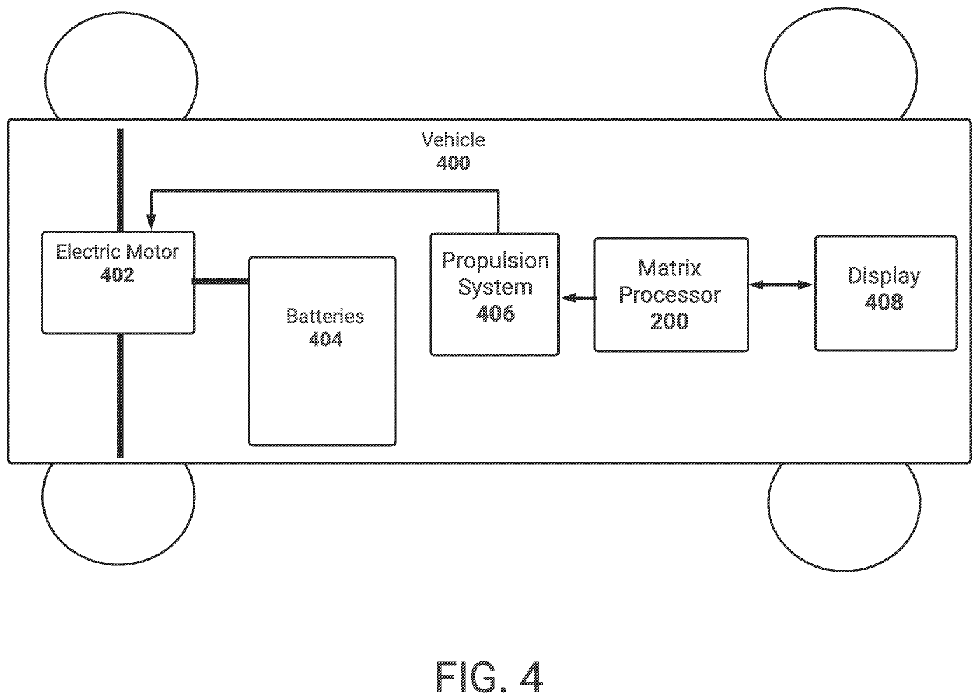

FIG. 4 illustrates a block diagram of a vehicle 400 (e.g., vehicle 102). The vehicle 400 may include one or more electric motors 402 which cause movement of the vehicle 400. The electric motors 402 may include, for example, induction motors, permanent magnet motors, and so on. Batteries 404 (e.g., one or more battery packs each comprising a multitude of batteries) may be used to power the electric motors 402 as is known by those skilled in the art.

The vehicle 400 further includes a propulsion system 406 usable to set a gear (e.g., a propulsion direction) for the vehicle. With respect to an electric vehicle, the propulsion system 406 may adjust operation of the electric motor 402 to change propulsion direction.

Additionally, the vehicle includes the matrix processor 200 which includes a multitude of enhanced multiply-accumulate units (MAC units) as described herein. The matrix processor 200 may process data, such as images received from image sensors positioned about the vehicle 400 (e.g., cameras 104A-104N). The vehicle processor system 100 may additionally output information to, and receive information (e.g., user input) from, a display 408 included in the vehicle 400.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A multiply-accumulate unit (MAC unit) included in a matrix processor, the matrix processor being configured to compute a forward pass through a neural network, and the matrix processor being configured for inclusion in a vehicle, wherein the MAC unit comprises:
a multiplier, wherein the multiplier is configured to receive (1) an input value of a window of input values and (2) a weight value set to negative one;
an adder, wherein the adder is configured to add a result received from the multiplier with a value in an accumulator of the MAC unit;
a multiplexer, wherein the multiplexer is configured to select between outputting (1) a result of the adder and (2) the input value; and
the accumulator, wherein the accumulator is configured to receive output from the multiplexer, and wherein the accumulator is configured to be enabled or disabled according to the result of the adder based on the MAC unit performing a particular convolutional operation.

2. The MAC unit of claim 1, wherein the MAC unit is configured to successively receive individual input values within the window of input values.

3. The MAC unit of claim 2, wherein the MAC unit is configured to identify a maximum value within the window of input values.

4. The MAC unit of claim 1, wherein the particular convolutional operation is max pooling.

5. The MAC unit of claim 4, wherein the multiplexer is configured to select outputting the input value.

6. The MAC unit of claim 1, wherein the particular convolutional operation is max pooling, and wherein based on the MAC unit performing processing associated with a convolutional layer the multiplexer is configured to select the result of the adder.

7. The MAC unit of claim 1, wherein the particular convolutional operation is max pooling, and wherein based on the MAC unit performing processing associated with a convolutional layer the accumulator is set to be enabled during performance of the processing.

8. The MAC unit of claim 1, wherein the particular convolutional operation is max pooling, and wherein a high bit of the result of the adder is used to enable or disable the accumulator.

9. The MAC unit of claim 1, wherein based on the input value being greater than a different value stored in the accumulator, the accumulator is configured to store the input value.

10. The MAC unit of claim 9, wherein the accumulator is configured to be enabled such that the accumulator is configured to store the input value.

11. The MAC unit of claim 1, wherein based on the input value being less than a different value stored in the accumulator, the accumulator is configured to be disabled such that the accumulator does not store the input value.

12. A matrix processor comprising a plurality of multiply-accumulate units (MAC units) according to claim 1.

13. The matrix processor of claim 12, wherein each MAC unit is configured to identify a maximum value of a different window of input values of a plurality of windows of input values.

14. A method implemented by a matrix processor, the method comprising:
obtaining information indicating that the matrix processor is to perform max pooling;
providing portions of input data to respective multiply-accumulate units (MAC units), wherein each MAC unit comprises:
a multiplier, wherein the multiplier is configured to receive (1) an input value of an individual portion of input values and (2) a weight value set to negative one;
an adder, wherein the adder is configured to add a result received from the multiplier with a value in an accumulator of the MAC unit;
a multiplexer, wherein the multiplexer is configured to select between outputting (1) a result of the adder and (2) the input value; and
the accumulator, wherein the accumulator is configured to receive output from the multiplexer, and wherein the accumulator is configured to be enabled or disabled according to the result of the adder based on the MAC unit performing a particular convolutional operation; and
causing, by the MAC units, of comparison of input values included in the windows of input values.

15. The method of claim 14, wherein the MAC unit is configured to successively receive individual input values within the window of input values.

16. The method of claim 15, wherein the MAC unit is configured to identify a maximum value within the window of input values.

17. The method of claim 14, wherein the particular convolutional operation is max pooling.

18. The method of claim 14, wherein the multiplexer is configured to select outputting the input value.

19. The MAC unit of claim 1, wherein the particular convolutional operation is max pooling, and wherein based on the MAC unit performing processing associated with a convolutional layer the multiplexer is configured to select the result of the adder.

20. The method of claim 14, wherein the particular convolutional operation is max pooling, and wherein a high bit of the result of the adder is used to enable or disable the accumulator.

21. The method of claim 20, wherein based on the input value being greater than a different value stored in the accumulator, the accumulator is configured to store the input value, and wherein the accumulator is enabled based on a high bit associated with the result of the adder.

22. The method of claim 14, wherein based on the input value being less than a different value stored in the accumulator, the accumulator is configured to be disabled such that the accumulator does not store the input value.
